(19) United States
(12) Patent Application Publication
(10) Pub. No.: US 2020/0082411 A1
(43) Pub. Date: Mar. 12, 2020

(54) Instantaneous Financial Transaction Processing Utilizing Distributed Ledger Technology

(71) Applicant: Chuck Lacona, West Des Moines, IA (US)

(72) Inventor: Chuck Lacona, West Des Moines, IA (US)

(21) Appl. No.: 16/565,160

(22) Filed: Sep. 9, 2019

Related U.S. Application Data
(60) Provisional application No. 62/728,395, filed on Sep. 7, 2018.

(51) Int. Cl. G06Q 20/42; G06Q 20/06; G06Q 20/22; G06Q 20/38

(52) U.S. Cl. CPC G06Q 20/425; G06Q 20/3829; G06Q 20/223; G06Q 20/0658

(57) ABSTRACT

A method for validating transactions in real time over an encrypted peer-to-peer network of computing devices. The preferred embodiment of the method of the present invention validates transaction instantaneously over a private network of computing devices using a common, encrypted communication protocol. The method of the present invention utilizes cryptography with public and private keys to authenticate digital signatures so that public keys are utilized to verify transaction requests on the consumer or merchant facing terminals, while private keys are utilized internally to secure the accounts and ledger stored on the peer-to-peer network. Each peer-to-peer member validates a transaction as it comes in and provides instantaneous results. Accordingly, an incoming transaction is validated as long as a majority of the peer-to-peer network members identify the transaction as valid.

### PRIORITY

This application claims priority to provisional application 62/728,395 filed on Sep. 7, 2018.

### FIELD OF THE INVENTION

The present invention generally relates to methods for network payments and financial exchange reconciliation utilizing a distributed ledger application systems.

### BACKGROUND

Generally speaking, blockchains are publicly accessible implementations of distributed ledger technology. Distributed ledger technology is unique in that it allows a peer-to-peer network of devices to hold and replicate a log of information, such as financial transactions, using a common method of encrypted communication. Typically, distributed ledger technology like blockchains take update requests, such as incoming requests for a financial transaction, and bundle them together into a “block” of transactions. The block is then distributed to the devices in the peer-to-peer network for validation and, thereafter, recordation. Once a block is recorded to the blockchain it is recorded across the network of peer-to-peer devices and, thus, is a publicly reviewable recordation of all transactions and information on the blockchain without having to rely on a central authority. Blockchains validate a transaction utilizing cryptography and digital signatures with public and private key components. Accordingly, blockchains, and more generally, distributed ledger technology is a practically unassailable, validated audit of a history of transactions or other stream of information.

However, since blockchains bundle multiple transactions together prior to sending them out for validation, the first transaction request will be required to wait until enough additional transactions come in to be bundled into a block. Additionally, even with other prior art distributed ledger technology applications that don't bundle transactions, the processes of validating the transaction can take a significant amount of time depending on the computing resources available in the peer-to-peer network. This is especially true if there is a larger volume of incoming transaction that will put considerable stress or load on the computing resources of the peer-to-peer network. Accordingly, there is a need in the art for a system that allows for real time processing and validation of transactions as they come in while providing a secure and unassailable audit trail.

### Objectives of the Invention

Thus, it is a primary objective of this invention to provide a financial transaction system configured to improve upon the art.

Another objective of this invention is to provide a financial transaction system configured to instantaneously process purchases, verify identities, and transfer payment simultaneously in real-time.

Yet another objective of this invention is to provide a financial transaction system configured to eliminate the need for batch processing.

Another objective of this invention is to provide a financial transaction system configured to instantaneously provide transaction analytics in real-time such that an organization may alter their sales agendas.

Yet another objective of this invention is to provide a financial transaction system configured to operate using a distributed ledger system controlled by a computer that processes all transactions in real-time.

Another objective of this invention is to eliminate the need to present a credit card to a merchant and instead a user's phone becomes their secured transaction device.

Yet another objective of this invention is to provide a financial transaction system configured to eliminate the need for common restrictions and fees associated with traditional credit card use in the event of theft or loss.

Another objective of this invention is to provide a financial transaction system having parental controls that restrict what a child user may or may not purchase.

Yet another objective of this invention is to provide a financial transaction system that provides for payroll transactions from business account to employee account without the use of checking account or credit card information.

### SUMMARY

The present invention provides, a method for validating transactions in real time over an encrypted peer-to-peer network of computing devices. The present system is a block chain system that can process transactions in real time rather than having to wait for lengthy or even overnight processing. The real time processing of transactions occurs from account to account within the block chain. An example of an account includes any financial institutional account or may include internal business transactional accounts including payroll.

The preferred embodiment of the method of the present invention begins processing purchases, validating a transactional identities using temporary transaction identifiers or tokens, transfer and process payments, and provide analytical data regarding the overall transaction instantaneously over a public or private network of computing devices using a common, encrypted communication protocol. The method of the present invention utilizes cryptography with public and private keys, transactional identifiers or tokens to authenticate digital signatures so that public keys are utilized to verify transaction requests on the consumer or merchant facing terminals, while private keys are utilized internally to secure the accounts and ledger stored on the peer-to-peer network. Peer-to-peer may be person to person, person to business, business to person, or business to business.

The computing devices of the network communicate with one another to verify the authenticity of the transactions through a process of consensus. Where a specified percentage of peer-to-peer network members, comprising at least a simple majority, identify the transaction as valid, the system will authentic process the transaction. Each peer-to-peer member validates a transaction as it comes in, rather than queuing the transaction in blocks. Moreover, by limiting the organization of blocks to a single transaction, the proof of work required to validate the transaction is reduced, thereby providing instantaneous results. In typical distributed ledger technologies, blocks consist of numerous transaction which each require proof of work for validation. Proof of work consists of solving mathematical puzzles in the form of a hash functions, integer factorization and even guided tour puzzle protocol, with each process require substantially computational power and time to solve. Accordingly, by reducing the block sizes to comprise of only single transactions, the computational power and time it takes each computing device within the network to complete the required proof of work is dramatically reduced in view of existing technologies.

### BRIEF DESCRIPTION OF THE DRAWINGS

FIG. 1 is a diagram of the process of the preferred embodiment of the present invention.

FIG. 2 is a diagram of a financial transaction system.

FIG. 3 is a diagram of a financial transaction system.

FIG. 4 is a schematic view of a financial transaction system.

### DETAILED DESCRIPTION

The following is a detailed description of a system for validating and processing information in real-time utilizing a peer-to-peer network of computing devices to process purchases, validate personal identities using temporary identifiers or tokens, transfer payments, and provide analytical data to a merchant regarding the overall transaction simultaneously over a nodal computer network. One particular use of such a method is to process and validate financial transactions such as money transfers and payment processing. Accordingly, for each of discussion and understanding, the following detailed description with reference to the aforementioned financial transaction system embodiment of the present invention. However, it should be appreciated by one skilled in the art that a method of the present invention may be used in other information processing applications where security and speed of validation are important. As such, information processed by the method may be varied without departing from the scope of the present invention.

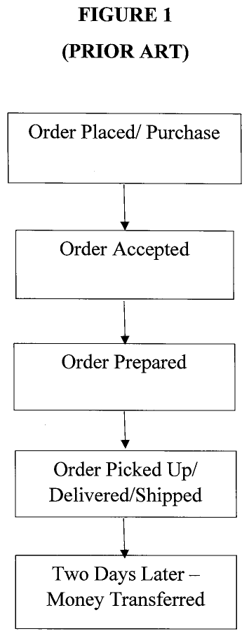

As provided in FIG. 1, a traditional credit card processing system requires a customer to place an order, thereby initiating a transaction. Thereafter, a query is sent to the credit card issuer to authorize the charge, however, the charge is not processed at that time. After receiving the authorization, the merchant will accept the order and then prepare the order for delivery. In the meantime, the merchant is still waiting on the funds to be transferred from the customer's credit card issuing bank, typically a merchant will have to wait days to receive the funds in their account. In some cases the order may be delivered prior to the merchant receiving the funds to fulfill payment on the order. Additionally, specifically with credit cards, merchants must earmark payments in case of charge backs from customers which can sometimes keep the merchant from utilizing the funds for months at a time. All the while, the merchant's inventory continues to be depleted fulfilling incoming orders.

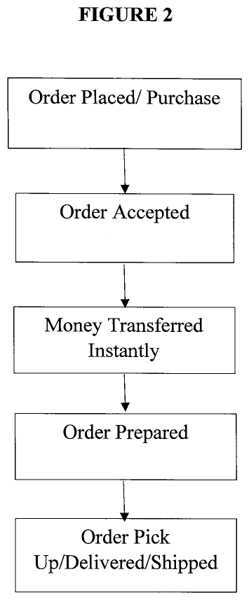

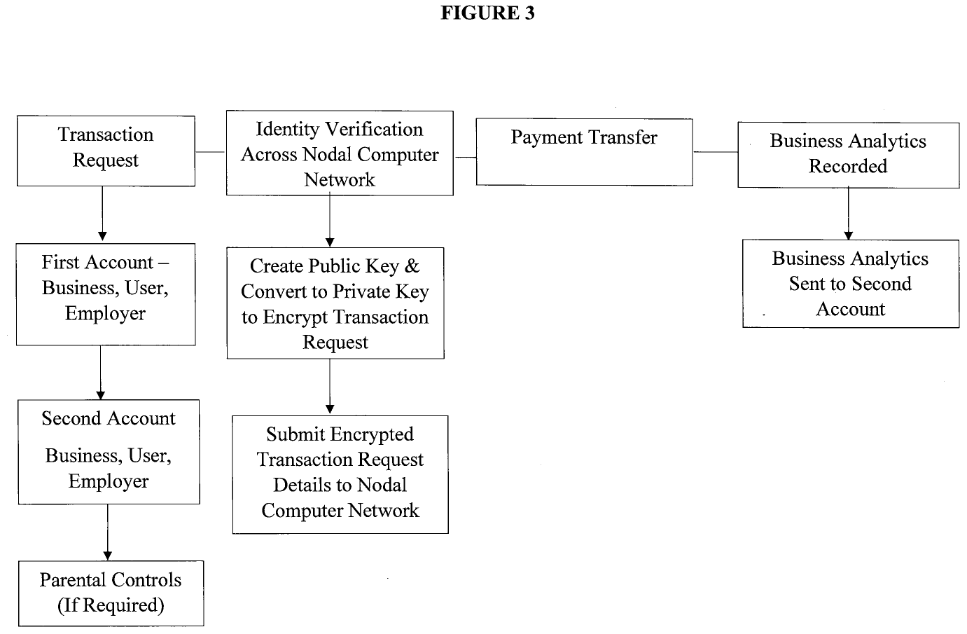

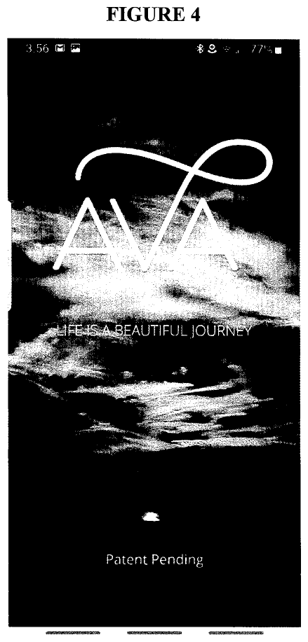

As depicted in FIGS. 2-4, the method of the preferred embodiment of the present invention provides a merchant with real time payment for orders. Specifically, an order is received by a merchant account and accepted based on the instantaneous validation of the transaction, i.e. the peer-to-peer network of computing devices that validate availability and authenticity of the funds and simultaneously record the transfer thereby transferring the funds from the customer's account to the merchant's account. As a result, the funds are available to the merchant as soon as the order is accepted. Thereafter, the merchant can prepare and deliver the order knowing the funds are already available in their account. In one embodiment, the user account and the merchant accounts are replaced by internal business transactional accounts including payroll and the like.

The real time transaction system verification and transfer occurs through a system of interconnected computing devices utilizing a common, secure communication protocol. The computing devices can be of various processing capabilities and operating systems as long as they are able to process the encrypted communication protocol and the associated public and private keys for the digital signatures associated with each transaction. More specifically, an incoming order from a customer requires the customer to authenticate ownership of the account and then utilizes a private key to generate a public key that is encrypted in the secure communication protocol to record the requested transaction to the distributed ledger stored on each of the computing devices (“nodes”) in the peer-to-peer network. The network may operate over the Internet or a local network when a user is in proximity to a physical store. The generated public key acts as a secure signature to verify the authenticity of the transaction request and to prevent any third-party alteration of the transaction after it has been initiated by the user or merchant but before it is sent to the nodes of the overall network. In the preferred embodiment, only one user can use the account and that user is whoever is signed into the transaction device, which may be a phone, and has purchase pin information. However, the user may send money to another account user so that another account user may request transactions.

Once an encrypted transaction request is received by a node it is distributed to all the nodes in the network and validated by decrypting the key and validating the authenticity of the signature and verifying the availability of funds to transfer through the process of Proof-of-Work. More specifically, Proof-of-Work is a consensus algorithm used in distributed ledger and blockchain technologies which confirms transactions by solving mathematical puzzles. These mathematical puzzles typically take the form of a hash function, integer factorization, guided tour puzzle protocols or other suitable computational functions. However, validating information through Proof-of-Work can be both time-consuming and resource intense. Accordingly, by presenting blocks with only single transactions, resource expenditure and time consumed validating the transactions may be reduced dramatically over current technologies. In verifying the transactions, the network of nodes simultaneously records the transaction, if valid, thereby transferring the funds from the customer to the merchant to finish the transaction. The network nodes ensure the validity of the transaction by communicating with one another and determining whether there is consensus as to the identify and contents of the transaction across the network of nodes. If the transaction's authenticity or availability of funds is unable to be verified by a majority of the networked nodes, i.e. the node network fails to reach consensus, the transaction fails and the merchant is alerted so that the order is not accepted and processed. The customer will also be alerted so that they may attempt to rectify the issue, e.g. insufficient funds, and try to process the order and transaction again. In one embodiment, the financial transaction system includes parental controls such that a parent may or may not allow their children to may particular purchases.

In the event that the accounts are internal business transactions such as payroll, the system remains the same except for the account users are employees and the business manager, owner or the like. Employers may then initiation the payment transaction request instantly rather than requiring the employee to provide a checking account or credit card information to the employer.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

What is claimed is:

1. A real-time payment processing and validation method comprising:
originating a transaction request;
validating personal information using encryption through a public key;
submitting the encrypted transaction request details to a network of computing devices having computing nodes;
transferring payment from a first account to a second account;
displaying business analytical data to a second account user; and
wherein originating a transaction request, validating personal information, submitting the encrypted transaction request details, transferring payment, and displaying business analytical data occur instantaneously, simultaneously, and in real-time.

2. The method of claim 1 further comprising approving the transaction if a majority of computing nodes successfully verify the authenticity of the transaction request or denying the transaction if a majority of computing nodes are unable to verify the authenticity of the transaction request.

3. The method of claim 1 wherein the verification of the authenticity of the transaction request is completed by comparing the decrypted transaction request details to previously verified records.

4. The method of claim 1 wherein the transaction request is recorded to a ledger system upon approval.

5. The method of claim 1 wherein funds associated with a transaction request are instantaneously transferred upon the approval of a transaction request by the network of computing devices.

6. The method of claim 1 wherein the public key for encryption is derived from a private token known only to authorized parties.

7. The method of claim 1 wherein the network of computing devices operates over the Internet.

8. The method of claim 1 wherein the first account is a user account and the second account is a merchant account.

9. The method of claim 1 wherein the first account is a first business account and the second account is a second business account.

10. The method of claim 1 the public key is a secure signature to verify the authenticity of the transaction request and prevent unauthorized access to either the first account or second account.

11. The method of claim 1 further comprising an alert system that alerts a first account user and a second account user when a transaction request fails to transfer between the first account and the second account.

12. A real-time payment processing and validation system comprising:
a transaction request;
personal information validation using encryption through a public key;
encrypted transaction request details submission to a network of computing devices having computing nodes;
payment transfer from a first account to a second account;
business analytical data display to a second account user;
wherein the transaction request, the validation of personal information, the submission of the encrypted transaction request details, the transfer of payment, and the display of business analytical data occur instantaneously, simultaneously, and in real-time; and
parental controls wherein a parent user may restrict a child's access to the first account.

13. A real-time payment processing and validation system comprising:
a transaction request;
personal information validation using encryption through a public key;
encrypted transaction request details submission to a network of computing devices having computing nodes;
payment transfer from a business account to an employee account;
business analytical data display to a business account user;
wherein the transaction request, the validation of personal information, the submission of the encrypted transaction request details, the transfer of payment, and the display of business analytical data occur instantaneously, simultaneously, and in real-time
